(19) United States
(12) Patent Application Publication
(10) Pub. No.: US 2002/0124880 A1
(43) Pub. Date: Sep. 12, 2002

(54) Irrigation valve

(76) Inventor: Akio Tanikawa, T okyo (JP)

Correspondence Address: ARMSTRONG,WESTERMAN & HATTORI, LLP, 1725 K STREET, NW., SUITE 1000, WASHINGTON, DC, 20006, US

(21) Appl. No.: 10/087,988

(22) Filed: Mar. 5, 2002

(30) Foreign Application Priority Data
Mar. 7, 2001 (JP) 62931/2001

(51) Int. Cl. F16K 31/04

(52) U.S. Cl. 137/78.3

(57) ABSTRACT

An irrigation valve is disclosed which requires no electric power, can be manufactured at low cost, is useful for large-scale irrigation, and which can operate automatically for a long period of time. This irrigation valve is simple in its piping system, but realizes controlling the watering adjusted to the drainage varied by locations or to the kinds of plant, in a vast agricultural land or a vast park. This irrigation valve thereby makes it possible to prevent soil, crops and plants from being badly effected by excessive irrigation, thus preventing environmental degradation, which is proceeding globally, and enabling the avoidance of food shortages. The irrigation valve according to the present invention formed of a vessel, at least a part of which is water-permeable, and a water-absorbable body housed in the vessel, wherein a pressure generated by volume expansion of the water-absorbable body is employed for automatically opening or closing a water supply pipe.

### BACKGROUND OF THE INVENTION

1. Field of the Invention

The present invention relates to a valve for liquid, and in particular, to an irrigation valve for watering plants.

2. Description of the Related Art

Most of the automatic watering devices are generally formed into systems involving electric moisture sensors and open-close valves, as described in Japanese Patent No. 25073738, thereby requiring a much manufacturing cost as well as electric power. Water supply devices requiring no electric power have been proposed, as described in Japanese Patent Unexamined Publication (Kokai) H11-239424, wherein an air pressure in an air-reservoir vessel is utilized, or wherein a capillary action is utilized. However, both of above are impossible to use for the irrigation of a large-scale area, and also difficult to use for the automatic watering for a long period of time.

Therefore, the purpose of the present invention is to solve the problems involved in the systems of the prior arts, such as requiring electric power, high costs, difficulties of miniaturization, impossibilities in irrigation of a large scale area, and difficulties of automatic water supply for a long period of time. Further the irrigation systems of the prior arts become very complicated and very large scale to control the watering adjusted to drainage varied by locations or kinds of plants in a vast agricultural land or a vast park.

Therefore, an object of the present invention is to provide irrigation valves, which work without electric power, reduce the cost of manufacture of the device, can apply to the irrigation of a large scale area, and can supply water automatically for a long period of time. Another object of the present invention is to provide irrigation valves by which a simple piping system realizes controlling the watering adjusted to the drainage varied by locations or to the kinds of plant, in a vast agricultural land or a vast park. Further the present invention realize cultivating plants on places difficult to cultivate such as a concrete wall surface.

The ultimate object of the present invention is to avoid food shortages by preventing environmental degeneration, which is currently proceeding on a global scale, as weel as by removing harmful effects of excessive irrigation on soil, crops and plants, through the realization of the aforementioned objects.

### BRIEF SUMMARY OF THE INVENTION

The irrigation valve according to the present invention is formed of a vessel, at least a part of which is water-permeable, and a water-absorbable body housed in the vessel, wherein a pressure generated by a volume expansion of the water-absorbable body is directly or indirectly employed for automatically opening or closing a water supply pipe.

It is known that most of water-absorbable natural materials such as protein and cellulose, or artificially synthesized water-absorbable materials such as water-absorbable polymers increase in volume to ten or more times by absorbing water as large as when they are dry. When water is supplied to a water-permeable vessel in which a water-absorbable body formed of such a water-absorbable material is enclosed hermetically, the pressure in the vessel increases. This pressure decreases when the water escapes to outside the vessel by an action such as evaporation or permeation.

A valve can be opened and closed by the aforementioned pressure generated in the vessel collapsing a part of a flexible water supply hose or actuating a piston in a cylinder. Thus the irrigation valve as claimed in claim 1, wherein the pressure generated by volume expansion of the water-absorbable body is directly employed, can be materialized.

Further, a valve can be made of a thin tube, branched from a main water supply pipe, introduced into a distinct sensor cylinder and the aforementioned direct valve disposed at midway in the thin tube. The valve disposed in the main water supply pipe can be opened and closed using the hydraulic pressure of the main water supply pipe by the aforementioned pressure generated in the vessel collapsing a part of a flexible water supply hose or actuating a piston in a cylinder. Thus the irrigation valve as claimed in claim 2, wherein the pressure of volume expansion of the water-absorbable body is indirectly employed, can be materialized.

### BRIEF DESCRIPTION OF THE DRAWINGS

FIGS. 1(a) and 1(b) show schematic cross-sectional views illustrating a first embodiment of the present invention, wherein FIG. 1(a) illustrates an opened state of the valve and FIG. 1(b) illustrates a closed state of the valve;

FIGS. 2(a) and 2(b) show schematic cross-sectional views illustrating a second embodiment of the present invention, wherein FIG. 2(a) illustrates an opened state of the valve and FIG. 2(b) illustrates a closed state of the valve;

FIGS. 3(a) and 3(b) show schematic cross-sectional views illustrating a third embodiment of the present invention, wherein FIG. 3(a) illustrates an opened state of the valve and FIG. 3(b) illustrates a closed state of the valve;

FIG. 4 is a schematic view illustrating a first applied embodiment of the present invention;

FIG. 5 is a schematic view illustrating a second applied embodiment of the present invention; and

FIG. 6 is a schematic view illustrating a third applied embodiment of the present invention.

### DETAILED DESCRIPTION OF THE INVENTION

Next, various embodiments of the present invention will be described in detail with reference to drawings.

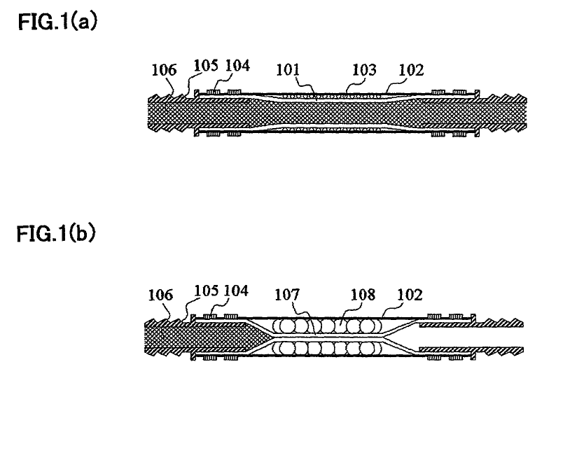

Referring to FIG. 1(a), a first embodiment of the present invention is constructed so that a water-absorbable body 103 is interposed between a flexible tube 101 and a water-permeable cover 102 completely covering the flexible tube 101. The both ends of the flexible tube 101 as well as the both ends of the water-permeable cover 102 are closely contacted with and fixed to hose-coupling ports 105 using hose bands 104. In order to prevent the water-absorbable body 103 from leaking outside the water-permeable cover 102, the material for the water-permeable cover 102 should be suitably selected. The water-permeable cover 102 should be fixed to the hose-coupling ports 105 with an adhesive and so forth so as to prevent making any leakage point in the water-permeable cover 102.

According to this first embodiment, the flexible tube 101 as well as the water-permeable cover 102 are respectively made of a single material as a whole. However, they may be constructed in such conditions that the external water can be supplied to the water-absorbable body 103, and that at least a port of the inner tube can be collapsed by the pressure generated by the supply of this external water. For example, just a port of the cylindrical body of the inner tube may be made flexible, and just a port of the cylindrical body of the outer cover maybe made of a water-permeable material. Further, it is also possible to dispose a tube-flattening disk in the flexible tube 101 so as to facilitate the collapsing of the flexible tube 101.

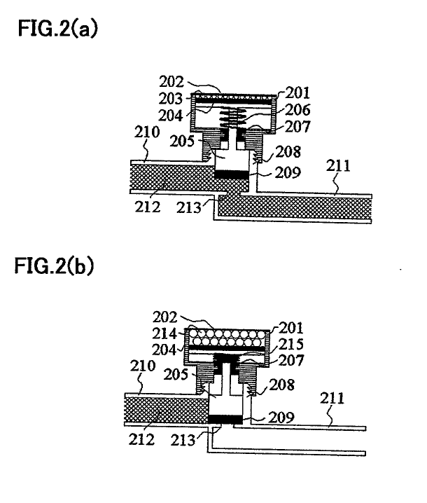

Next, referring to FIG. 2(a), a second embodiment of the present invention is featured in that a piston 205 is disposed inside a cylinder 201 which is screw-engaged with a valve block 208 having a water inlet port 210, a water outlet port 211, and a valve hole 213. In this case, a water-absorbable body 203 is housed in a space between a packing A 204 which is attached to a top of the piston 205 and a water-permeable cover 202 which is attached to an upper opening of the cylinder 201. Although this piston 205 sustained by a packing B 207 is enabled to smoothly move up and down in the cylinder 201, this piston 205 is pressed against the upper position by a spring 206 when the water-absorbable body 203 is not expanded. Packing C 209 is also attached to the bottom of piston 205, so that the packing C 209 can completely close the valve hole 213 of the cylinder 201 when the piston 205 is at the bottom of the cylinder 201.

According to this second embodiment, the inner diameter of the upper opening of the cylinder 201 is made larger than the inner diameter of its lower port. Although it may not be absolutely required for the cylinder 201 to be constructed in this manner, this structure yields that the piston 205 can be pushed downward with larger force. As for another method to push the piston 205 downward with further larger force, it is also effective to adopt a method wherein the pressure generated by the water-absorbable body 203 is transmitted to the piston 205 via a force-amplifying device such as a lever.

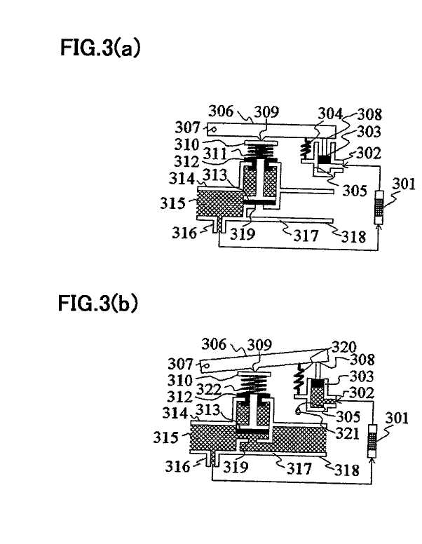

Referring to FIG. 3(a), a third embodiment of the present invention is featured in that water is introduced into a valve art 301 similar to the aforementioned first or second embodiment from a branched port 316 provided at a water inlet where the hydraulic pressure of the water supply pipe exists constantly. Piping is provided between a water outlet port of the valve 301 and a sensor cylinder 302, so that water is introduced into the sensor cylinder 302 when the valve 301 is opened. A sensor piston 303 is inserted into the sensor cylinder 302, and the sensor cylinder 302 is arranged at a position where the sensor piston 303 can push up the point of force 308 of the lever 306. The sensor cylinder 302 is provided with a small hole 305 from where a hydraulic pressure in the sensor cylinder 302 can escape. A spring A 304 is provided so that the point of force 308 of the lever 306 as well as the sensor piston 303 are pulled down by the spring A 304, when no hydraulic pressure exists in the sensor cylinder 302.

Further, a cylinder valve block 317 and a piston introduced into the cylinder valve block 317 are arranged in such a manner that the top end of a piston 310 can be contacted with the point of action 309 of the lever 306. The piston 310 is sustained by a packing A 312 to be able to move up and down inside the cylinder valve block 317. Further, the piston 310 is pressed against the point of action 309 of the lever 306 by the compressed spring B 311. A packing B 313 is provided at the lower end of the piston 310 so that the valve hole 319 of the cylinder valve block 317 is completely closed by the packing B 313 when the piston 310 is fully pushed down by the lever 306.

For the materials for the water-absorbable body which is an essential element in constructing the valve of the present invention, various kinds of materials can be used. For example, a natural material such as mannan extracted from plant roots, fibers of marine plants, etc., or a synthetic material such as various kinds of plastic material including starches, a carboxymethylcelluloses, polyacrylic acids, povals, etc. can be used. These materials can be suitably selected when designing the valve by taking into consideration the expansion coefficient thereof or the pressure to be generated when these materials absorb water.

For the water-permeable cover, various materials can be used. For example, natural leather, natural fiber, plate-like charcoal, or synthetic leather or fiber which is made of polyvinyl alcohol, for instance, can be used. The water-permeable material may be covered with a stainless steel mesh or a plastic mesh so as to reinforce the physical. It is also possible to use a composite material comprising a water-permeable material and a high-strength material.

The structure of a cylinder and a piston used in the aforementioned embodiments can be changed with any structure as long as a sealing performance and a linear movement can be ensured. For example, the structure can be modified, in design, into a bellows-like structure or the like. Further, the aforementioned structure using a lever can be modified, in design, into a hydraulic system.

The structures according to these three embodiments can also be utilized, as they are, as a valve for controlling general liquids such as oil or an organic solvent. In such case, materials having resistance to the particular liquids to be controlled should be selected in constructing these valves.

Explanation on the Operation of these Valves

First, the operation of the valve according to the aforementioned first embodiment will be explained with reference to FIGS. 1(a) and 1(b). Under the conditions where external water is not supplied to the valve and hence the water-absorbable body 103 is dry, the volume of the water-absorbable body 103 is small, thereby permitting water 106 to flow inside the flexible tube 101 as shown in FIG. 1(a). When water is supplied to the water-absorbable body 103 from outside the system, the flexible tube 107 is collapsed by the pressure generated by the expansion of the water-absorbable body 108 as shown in FIG. 1(b), thereby preventing flow of the water 106.

Subsequently, when the supply of water from outside the system is stopped, water is gradually lost from this expanded water-absorbable body 108, thereby permitting the valve to return to the state shown in FIG. 1(a) from the state shown in FIG. 1(b). The quantity change or type change of the water-absorbable body 103 can control the speed of the aforementioned transformation.

Next, the operation of the valve according to the aforementioned second embodiment will be explained with reference to FIGS. 2(a) and 2(b). Under the conditions where external water is not supplied to the valve and hence the water-absorbable body 203 is dry, the volume of the water-absorbable body 203 is small. Hence, the piston 205 is pushed up by the effect of the spring 206, thereby permitting water 212 to flow through the valve hole 213 as shown in FIG. 2(a). When water is supplied to the water-absorbable body 203 from outside the system, the piston 205 is pushed down by a pressure generated by the expansion of the water-absorbable body 214 as shown in FIG. 2(b), thereby closing the valve hole 213 and hence preventing flow of the water 212.

Subsequently, when the supply of water from outside the system is stopped, water is gradually lost from the expanded water-absorbable body 214, thereby the valve returns to the state shown in FIG. 2(a) from the state shown in FIG. 2(b). The speed of the aforementioned transformation can be controlled by the quantity change or type change of the water-absorbable body 203 or by turning the screw of the cylinder 201 against the valve block 208.

Next, the operation of the valve according to the aforementioned third embodiment will be explained with reference to FIGS. 3(a) and 3(b). Under the condition where water exists in abundance outside the system, as shown in FIG. 3(a), the valve 301 is closed and water is not supplied to the sensor cylinder 302 and hence the sensor piston 303 remains lowered. At the same time, the point of force 308 of the lever, the point of action 309 of the lever, and the piston 310 are all pushed down so as to close the valve hole 319, thereby preventing flow of the water 315.

When water is no longer present outside the system, as shown in FIG. 3(b), the valve 301 changes into an opened state, thereby injecting water into the sensor cylinder 302 and hence pushing up the sensor piston 303. At the same time, the point of force 308 of the lever, the point of action 309 of the lever, and the piston 310 are all pushed up so as to open the valve hole 319, thereby permitting flow of the water 315.

When the external water becomes enough, the valve 301 closes. Subsequently the water in the sensor cylinder 302 discharges from the small hole 305 for leaking the hydraulic pressure. Thus the valve returns to the state shown in FIG. 3(a) from the state shown in FIG. 3(b).

The operation feature of this third embodiment is that the transformation from the closed state (FIG. 3(a)) to the opened state (FIG. 3(b)), or from the opened state (FIG. 3(b)) to the closed state (FIG. 3(a)) occurs rapidly, so that the period of the semi-opened state can be minimized. This feature is advantageous when it is desired to make constant the quantity of water supply per unit time when the valve is in an opened state, as in the case of irrigation with sprinklers.

### EXAMPLES

Next, specific examples in which the present invention is specifically applied will be explained with reference to drawings.

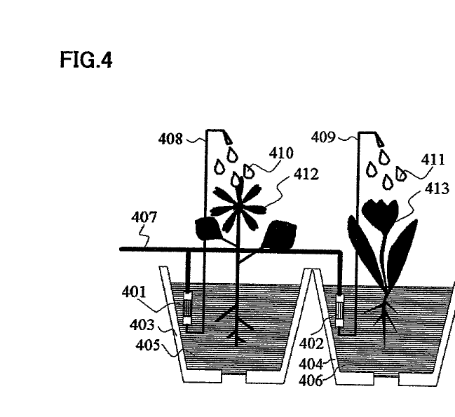

FIG. 4 shows an example wherein water is automatically supplied to flowerpots using valves representing the present invention. Soil A 405 and soil B 406 are placed into a flowerpot A 403 and a flowerpot B 404, respectively, to thereby cultivate a plant A 412 and a plant B 413, respectively. In this case, valves A 401 and B 402 according to the present invention, each connected to a single piece of conduit tube 407, are installed inside these soils. The valves A 401 and B 402 have differing characteristics that are suited to each of the respective plants, and are connected to a water supply pipe A 408 and a water supply pipe B 409, respectively. Then, hydraulic pressures in the conduit tube 407 are always kept suitable. For instance, if a dry atmosphere is favorable for the plant A 412, a valve that closes with a small quantity of water may be applied to the valve A 401. On the other hand, if, for instance, a wet atmosphere is favorable for the plant B 413, a valve that does not close unless a large quantity of water may be applied to the valve B 402. In accordance with above, the water 410 is automatically supplied to the plant A 412 from the water supply pipe 408 only when the soil A 405 becomes quite dry. On the other hand, the water 411 is automatically supplied to the plant B 413 from the water supply pipe 409 as soon as the soil B 406 becomes only slightly dry. When the content of water in the soil A 405 or the soil B 406 is optimized, the watering is stopped automatically by means of the valve A 401 or the valve B 402 respectively.

Although only two flowerpots are shown in the aforementioned example, the valve of the present invention can be similarly applied to a larger number of flowerpots, optimizing automatically the watering for each of the flowerpots respectively.

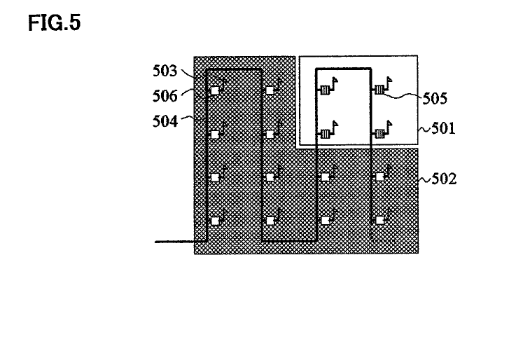

FIG. 5 shows another example, wherein water is automatically supplied to a vast area of agricultural land using valves representing the present invention. When a crop is cultivated in arable land A 501 and another crop in arable land B 502, a large number of valves A 505 and valves B 506, each having characteristics suitable to the respective crops, are connected to a line of conduit pipe 504. These valves A 505 and B 504 are buried in the arable land A 501 and B 502, and sprinklers 503 are connected to each of these valves A 505 and B 504. Then, hydraulic pressures in the conduit pipe 504 are constantly kept suitable.

In accordance with above, different kinds of watering can be automatically supplied to arable land A 501 and arable land B 502, simultaneously the water content within the identical arable land is homogenized in the optimum. Although the explanation of this example is described assuming the case of ordinary field, this construction can also be applied to keep the water level constant in the case of a rice paddy field or a pond. In such case, a single unit of the valve of the present invention may be installed in each of the rice paddy fields or ponds at the level of the favorable water level in each of the fields or ponds.

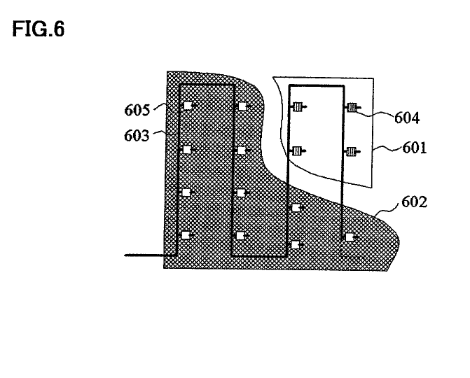

FIG. 6 shows a further example wherein water is automatically supplied to a park or garden using a valve representing the present invention. A large number of valves A 604 and B 605 each suitable for a flower bed 601 and lawn area 602, connected to a line of conduit pipe 603, are buried under the flower bed 601 and the lawn area 602. In this case, the outlet ports of these valves are left open. Then, hydraulic pressures in the conduit pipe 603 are constantly kept suitable.

In accordance with above, the watering suited each location can be automatically performed even in a vast park or garden. Moreover, since the water-supply installation can be buried entirely under the ground, the beautiful appearance of a park or garden will not be spoiled. In addition, the valve in accordance with the present invention can be also applied to a grass-covered baseball field, soccer field, a lawn tennis court, a golf course, etc. where sports are taken.

Furthermore, when the valve of the present invention is installed on a concrete wall surface, the wall surface can be kept in a wet state. Consequently, plants can grow on the wet wall surface, thus realizing cultivation of plants on the outer surfaces of buildings or bridges.

Effects of the Invention

A first effect of the invention is the saving of irrigation water. The water supply to plants is usually performed excessively so as to avoid a shortage of water for the plants. However, when the valve of the present invention is used, the quantity of water supplied to plants can be optimized, thereby making it possible to reduce the amount of irrigation water.

A second effect of the invention is the promotion of the growth of crops or plants. Although a vast area of agricultural land seems uniform, the drainage thereof differs depending on the positions within the agricultural land. Therefore, when the valve of the present invention is used, the quantity of water to be supplied to the agricultural land can be optimized with the wetness of each positions, thereby making it possible to go promote the growth of crops or plants.

A third effect of the invention is the labor saving in irrigation work. Namely, once the valve of the present invention is installed, the unmanned irrigation can be performed for a long period of time, as long as the hydraulic pressures in the system is kept larger than a lower limit. Moreover, any energy else such as electric power is not necessary for operating the valve. Therefore, it is possible to perform the stable automatic irrigation, even in a region or country where a stable supply of electric power cannot be assured.

A fourth effect of the invention is the cultivation on places where cultivation had been conventionally considered difficult. It is possible, thereby using the valve of the present invention, to keep a vertical concrete wall surface in a wet state. Consequently, plants can grow on the wet wall surface, thus realizing cultivation of plants on the outer surfaces of buildings or bridges.

1. An irrigation valve formed of:
a vessel, at least a part of which is water-permeable; and
a water-absorbable body housed in the vessel;
wherein a pressure generated by a volume expansion of the water-absorbable body is employed for automatically opening or closing a water supply pipe.

2. An irrigation valve formed of:
a thin tube which is branched from a main water supply pipe;
wherein the opening and closing of said thin tube is automatically effected by means of the irrigation valve as claimed in claim 1; and the opening and closing of said main water supply pipe is effected by a hydraulic pressure in said thin tube which is branched from said main water supply pipe.
